(19) United States
(12) Patent Application Publication
(10) Pub. No.: US 2007/0276674 A1
(43) Pub. Date: Nov. 29, 2007

(54) Defining and sizing feasible approaches to business needs within an integrated development process

(76) Inventor: Merzad Hemmat, Lenexa, KS (US)

Correspondence Address: SPRINT, 6391 SPRINT PARKWAY, KSOPHT0101-Z2100, OVERLAND PARK, KS, 66251-2100, US

(21) Appl. No.: 10/429,615

(22) Filed: May 5, 2003

Related U.S. Application Data
(60) Provisional application No. 60/404,824, filed on Aug. 19, 2002.

(51) Int. Cl. G06Q 10/00; G05B 19/418; G06Q 30/00

(52) U.S. Cl. 705/1; 705/8

(57) ABSTRACT

A process for defining and selecting integrated potential approaches (software, hardware, networking, and operations approaches) for addressing a business need. The process can include providing an identification of a business need in a concept document. A meeting that includes representatives of IT, network, and operations from each potentially impacted business domain can be held and can result in additions to the concept document identifying at least one proposed approach. An architecture blueprint can be created as a result of the meeting. Impacted systems for each proposed approach can be identified. The entire concept document and the architecture blueprint can be provided to representatives of each impacted system to determine the estimated level of effort for the development and implementation of the concept.

### CROSS-REFERENCE TO RELATED APPLICATIONS

This application claims priority from U.S. Provisional Application Ser. No. 60/404,824, filed Aug. 19, 2002 and entitled “Enterprise Architecture Development Process” which is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the use of consistent checkpoints in the process of enterprise-wide software development to allow significant events to occur in a predictable, scheduled manner. More specifically, methods are provided that ensure the alignment of the software development process with the strategic business intent of an enterprise.

### BACKGROUND OF THE INVENTION

The rapid evolution of computer and communication technologies coupled with the robust economies of the 1980s and 1990s resulted in unprecedented growth in the information technology field. In a growth economy, the need to establish a competitive advantage drove companies to faster and faster rates of change to support new product offerings and expanded services. As a result of these market pressures and time constraints, most companies elected to support new products and services by adding additional back office systems. However, due to the lack of mature integration technologies, the new systems were connected to the existing IT systems by making direct connections to the software routines already in use. The vulnerability of this design is that a change in one system precipitates a “ripple effect” change in every system it connects with. Over time, this incremental stacking of software systems can result in an integration ceiling. That is, at a certain point, more effort is spent on the connections than on new functionality and further expansion becomes cost prohibitive.

In the late 1990s, new integration technologies emerged that made it possible to “loosely couple” applications so that systems are no longer directly connected. Thus, changes in one system would not cause a ripple effect in any other systems. The most notable of these technologies were Message Oriented Middleware (MOM), Publish and Subscribe messaging, and Object Request Brokers. These technologies enabled companies to re-architect their conglomeration of systems into an architecture that allows them to expand in a cost-effective manner. Such technologies that address the problem of integrating existing systems with new systems in an organized, efficient, and economically scaleable manner can be referred to collectively as Enterprise Application Integration (EAI). Four components of EAI are typically defined: Framework, Methodology, Approach, and Service Delivery. Frameworks depict and define relationships between Enterprise Architectures, such as Business, Conceptual, and Process Architecture, and Enterprise Application Integration. Frameworks also describe the points where work products defined in any methodology must interface. Methodologies define the semantics and notation describing rules governing and relationships between work products in the context of a Framework. Approaches solve problems associated with a specific objective by delivering work products that are methodologically, and therefore architecturally, consistent. Delivery is the instantiation of an Approach in order to produce those work products necessary to solve a real-world problem in an efficient, repeatable manner.

A desired method of transforming a disparate grouping of systems that were incrementally cobbled together into a stable, extensible, and affordable “system of systems” is to engineer it through detailed analysis and design. The software engineering discipline that addresses EAI and the underlying integration issue is the domain of Enterprise Architecture. Enterprise architects typically realize architectures by specifying the components to be used (hardware, software, network, etc.); depicting how the components fit together (where and when in the process); clearly defining the interfaces and boundaries between components; setting guidelines and standards; and determining the layers, services, dependencies, and abstraction levels.

These engineering efforts are typically broken down into several subordinate areas each of which are focused on a specific integration area. The subordinate areas can be referred to as Platform Integration, Data Integration, Systems Integration, Business Process Integration, and Business Integration. The areas of integration are hierarchical and their ease of implementation and value are generally inversely proportional. That is, the areas at the beginning of the preceding list have the greatest ease of implementation and the lowest value to an enterprise while the areas at the end of the list have the least ease of implementation and the highest value to an enterprise.

The types of architecture disciplines are closely aligned with the types of integration problems, with “Enterprise Architecture” serving as the over-arching architecture domain. The architecture disciplines that can comprise Enterprise Architecture are Business Architecture, Conceptual Architecture, Process Architecture, Technical Architecture, Information Architecture, and Application Architecture. Business Architecture enables the enterprise to define its desired future by systematically exploring and capturing its unique purposes, goals, strategies, and objectives; outlining the fundamental structures, processes and capabilities needed to fulfill its strategic intent; documenting these in ways that can meaningfully guide and influence the organization; and providing a framework for comparing and selecting competing business alternatives.

Conceptual Architecture enables the business to evolve its current inadequate automated systems into its ideal future systems by creating blueprints (targets) that outline the desired form of ideal future systems; identifying patterns and leverage points across multiple projects to expose hidden synergy; advocating frameworks that isolate change, increase flexibility, reduce cost, and speed construction; and building individual project blueprints that meet immediate needs while creating future opportunities.

Process Architecture enables the business to convert desired business concepts into clear, actionable solution specifications by documenting and clarifying the business requirements that must be fulfilled; defining conceptual solutions that convert business requirements into systems requirements; and clearly documenting the sequence and content of systems interactions required to create solutions.

Technical Architecture helps the business make wise choices in selecting and applying software tools and technologies by tracking industry trends in software technology, evaluating and recommending software that is applicable broadly across the enterprise, monitoring the evolution of key software used within the enterprise and advising on needed changes, and building consensus on the appropriate use of software technology within the business.

Information Architecture enables the enterprise to effectively organize and leverage its data resources by defining the key information assets owned by and available to the business; creating the processes, frameworks, and tools needed to fully leverage data as a corporate asset; and providing the technical expertise needed to apply and support database technology across the business.

Application Architecture defines the applications required to support the business functions and manage the information within the business environment by identifying candidate applications and their data stores needed to support the business function; based on all business, functional and system requirements, creating application definitions that describe what each of the applications should perform; identifying the business functions that are directly supported or performed by each application; and relating each application in the application architecture to existing systems.

For each type of integration problem area being addressed, a corresponding EA discipline is typically needed. In some cases, a single Enterprise Architecture discipline can deal with multiple integration areas. Whether the various disciplines are assigned to a centralized EA organization or are matrix managed is dependent on the constraints of the parent IT organization.

### SUMMARY OF THE INVENTION

An embodiment of the invention is a process for defining and selecting integrated potential software, hardware, and networking approaches for addressing a business need. The process can include providing an identification of a business need to at least one conceptual architect in a concept document. The architect can identify the potentially impacted business domains in the concept document. A meeting can be held that includes a representative of IT, a representative of network, and a representative of operations from each potentially impacted business domain. The meeting can result in additions to the concept document identifying at least one proposed approach. Impacted systems for each proposed approach can be identified. The entire concept document can be provided to representatives of each impacted system for feedback before final selection of a proposed approach or initiation of efforts to implement a proposed approach. What is referred to as a conceptual architect can actually be a group of more than one conceptual architect. The group of conceptual architects can identify the potentially impacted business domains in the concept document and further initially identify at least one proposed approach to take to the meeting of the representatives of the potentially impacted business domains. The representatives of each impacted system can provide estimates of the Level of Effort for each proposed approach. An architecture blueprint can be created as a result of the meeting. The business domains can comprise infrastructure buildout, customer acquisition, service delivery, revenue management, customer care, and service assurance. The impacted systems within the infrastructure buildout business domain can comprise a network provisioning system, the impacted systems within the customer acquisition business domain can comprise sales and order creation systems, the impacted systems within the service delivery business domain can comprise network facility management systems, the impacted systems within the revenue management business domain can comprise invoice processing systems and message processing systems, the impacted systems within the customer care business domain can comprise customer care operations, and the impacted systems within the service assurance business domain can comprise performance monitoring and troubleshooting systems. The concept document provided to the architect can be a Concept Analysis Review Document comprising a section with concept information and the sponsor view of the concept, another section with an approach and feasibility determination, another section describing systems that might be impacted, and another section with concept estimation results. The section with concept information and the sponsor view of the concept can comprise a subsection describing the capabilities and constraints that a proposed approach to a problem is introducing. The capabilities and constraints can be categorized according to the business domains within an enterprise. The section with concept information and the sponsor view of the concept can further comprise a subsection of general administrative information, another subsection of context information, and another subsection of target information.

An alternative embodiment is a method of determining a potential approach and estimating a level of effort for an identified concept. The method can include having a business unit sponsor identify a concept including a business intent and an object desired and identifying all business domains potentially impacted by the concept. A meeting can be held that includes a representative of IT, network, and operations from each potentially impacted business domain. A plan can be created in the meeting that establishes at least one potential approach to the concept, the feasibility of the approaches, the systems that are actually impacted, and the functions and organizations that are impacted by the concept. All established potential approaches can be recorded in a concept document. The entire concept document can be provided to representatives of each actually impacted system. The representatives of each actually impacted system that will complete the project can estimate a level of effort needed to complete their portion of the project based on the information in the entire concept document. After identification of a concept by a business unit sponsor and before holding a meeting with representatives of each potentially impacted business domain, a meeting of a group of conceptual architects can be held. The group of conceptual architects can identify the potential approaches to take to the meeting of the representatives of the potentially impacted business domains. The concept document can be a Concept Analysis Review Document comprising a section with concept information and the sponsor view of the concept, another section with an approach and feasibility determination, another section describing systems that might be impacted, and another section with concept estimation results. The estimate of the level of effort can be placed in the concept estimation results section of the Concept Analysis Review Document. An architecture blueprint can be created as a result of the meeting. The business domains comprise infrastructure buildout, customer acquisition, service delivery, revenue management, customer care, and service assurance. The impacted systems within the infrastructure buildout business domain can comprise a network provisioning system, the impacted systems within the customer acquisition business domain can comprise sales and order creation systems, the impacted systems within the service delivery business domain can comprise network facility management systems, the impacted systems within the revenue management business domain can comprise invoice processing systems and message processing systems, the impacted systems within the customer care business domain can comprise customer care operations, and the impacted systems within the service assurance business domain can comprise performance monitoring and troubleshooting systems.

### BRIEF DESCRIPTION OF THE DRAWINGS

FIG. 1 is a block diagram depicting an embodiment of the Feasibility process;

FIG. 2 is a block diagram depicting an embodiment of the Estimation process; and

FIG. 3 is a diagram depicting an alternative embodiment of the Feasibility process.

### DETAILED DESCRIPTION OF THE PREFERRED EMBODIMENTS

An Enterprise Development Process (EDP) can be employed to facilitate the integration of enterprise architecture. EDP provides rigor to the process of enterprise-wide software development while accommodating flexibility. Consistent checkpoints throughout the process allow significant events to occur in a predictable, scheduled manner. The process typically comprises five phases: Define, Discover, Design, Develop, and Deploy. In the preferred embodiment, an additional sixth phase is a Demand phase that addresses reactive and proactive maintenance of operational systems and feedback for long-term optimization.

The Define phase encompasses processes that define the business intent and concepts that are aligned with the business intent. Among the business needs that can be addressed by the Define phase are new product/service offerings, enhancements to existing product/service offerings, infrastructure buildout and/or process improvement opportunities. Robust concept definition and ensuing communications ensure a proposed approach is on target with what a business wants delivered, as well as alignment with strategic network and IT architectures. As a side benefit, the Define phase can result in a more accurate LOE estimation in a more timely manner.

The Define phase typically comprises four steps, Intent, Ideation, Feasibility, and Estimation. Intent refers to processes that help define the business's strategic intent through the integration of mission, goals, objective, and capability models. The Intent process is typically carried out by personnel from the business side of an enterprise. Ideation encompasses formal and informal idea generation and the rigor of idea selection via validation against strategic intent. In the Ideation step, a problem is defined by describing what a business wants in the context of Intent. The problem statements are then translated into concepts that can be detailed in a concept document. As used herein, the term “concept document” does not necessarily refer only to a printed document but can in general refer to any collection of information. For example, the concept document can be stored as a single computer file or as a set of computer files accessible as a whole from a single interface. In an embodiment of the invention, the concept document is a Concept Analysis Review Document (CARD), which is described in detail below. The CARD specifically (or more generally the concept document) can serve as both a guide to collecting information pertinent to a problem and a repository for information that has been collected.

When a business need has been identified in the Intent and Ideation steps and documented in the concept document, the Feasibility step of the Define phase can begin. The Feasibility step facilitates determination of technical approach, critical functional impacts, impacted systems, and overall feasibility of concepts prior to Estimation. Customer expectations can be managed by determining if the customer's expected delivery date is feasible. Within the Feasibility step, a concept is typically reviewed for completeness and then classified according to size, complexity, and proposed process paths. It can then be decided whether or not a feasibility determination meeting needs to be held. The goal of the feasibility determination meeting is to determine architectural approaches that are operationally feasible. The feasibility determination meeting is typically required if multiple systems are impacted, if integration of third-party systems or software is involved, if information technology (IT) or network architecture is impacted, or if the project provides new products or services. The feasibility determination meeting can typically be bypassed if only a single system is involved, if there is no new IT or network impact, or if a previous system or installation is being refined. A review by at least one conceptual architect can identify the potentially impacted business domains in the concept document. During the feasibility determination meeting, representatives (typically architects) for each potentially impacted business domain within the enterprise determine a technical approach to a concept. The business domains can follow the domains discussed in the Telecom Operations Map published by the Tele-Management Forum, the eTOM published by the Tele-Management Forum, or other business alignment used by the enterprise. The architects can come from both the network and the IT fields. Operations representatives can then determine the operational feasibility of the approach. In a preferred embodiment, at least one and preferably a group of conceptual architects may participate in a planning meeting or meetings which can include the identification of the potentially impacted business domains discussed above and could additionally include determination of the complexity of the concept and hence the path the concept would follow through the process. A lead architect is also assigned to the concept during this meeting. The lead architect can be an IT, Network or Operations architect. It is the responsibility of the lead architect to take the concept through the feasibility and estimation steps. Preferably, the planning meetings may also provide an initial finding and assessment of potential approaches to be reviewed in the feasibility determination meeting for formal determination to proceed to estimation. After the feasibility determination meeting is held, the architects can determine the systems that might be impacted by the approach.

The Feasibility determination process can be guided by the concept document. Completion of the concept document ensures that all issues regarding the feasibility of a project are adequately addressed. In addition to the completed concept document, an Architecture Blueprint showing diagrams of all impacted systems can be created as the result of the Feasibility step. Creation of the Architecture Blueprint can be bypassed if there is no impact to IT or network architecture. The Feasibility step is typically performed before an estimation of costs is made and before a solution is designed. In summary, the Feasibility step can comprise determining technical approaches to a concept, the feasibility of those approaches, and identification of the systems impacted by the approaches, and a recommended approach.

The Estimation step aids with prioritization and investment decisions by facilitating estimation of the level of effort (LOE) likely to be needed to complete a project. As in the Feasibility step, the CARD can serve as a guide to ensuring that Estimation is properly carried out. The information obtained in the Feasibility step can be placed in the concept document and passed on to the representatives of the impacted systems. The representatives of the impacted systems can review the concept document and the Architecture Blueprint, if one is produced, and provide an estimated LOE for the approaches described. The estimated LOEs are then typically reviewed by an architect to ensure that the estimates are reasonable and appropriate. In one embodiment, an appropriate capacity of personnel, hardware, and other resources can then be reserved as needed to complete a project.

The development and implementation of the CARD (Concept Analysis Review Document) supports the EDP process. The CARD defines the desired capabilities and constraints of a concept and acts as a traceable record of the business need a project is intended to fulfill. The document is typically divided into four sections. Section 1 of the CARD is typically completed at the end of the Ideation step and can document the concept from the point of view of the concept's sponsor. The sponsoring organization can be a business unit, an IT or network unit, or any organization that desires any type of development. The concept's sponsor or a representative of the concept's sponsor is typically responsible for completing Section 1 of the CARD and this is typically the only section that the sponsoring organization completes. Section 1 is the only section that needs to be completed for acceptance of a concept into the Feasibility step. Section 2 and 3 are completed after the completion of the Feasibility step. Section 2 can summarize the approach, feasibility, and functional impact discussions and recommendations. Section 3 can document the systems that will be impacted by the concept. Section 4 can reflect the results of analyzing the concept through the Estimation step. This section captures the resource requirements necessary to deliver the concept. In alternative embodiments, an appendix can include financial or approval documents. A history of changes to the CARD can also be included in an appendix.

Four general categories of information can be included in Section 1: general administrative information for tracking and funding purposes, context information about where a concept fits into an enterprise and with related projects, target information about what the intended market uses and volumes are, and detailed information on capabilities and constraints.

Within the administrative information category, subcategories can include general administrative information, a concept category, the concept purpose and objectives, and the scope of costing information. The general administrative information subcategory can contain the following fields. A Concept Name field can contain a short description of the concept that communicates the intent of the concept. A Submission Date field can contain the date when the CARD was submitted by the concept representative. A Tracking Number field can contain a number that uniquely identifies the concept to be used for tracking, identification, and management of the concept by all affected areas. A Funding Business Unit field can contain the business unit that is paying for the concept or project. An Expected Delivery Date field can contain the date that the project must be migrated to production for user testing. This date defines the timeliness for delivery of the concept to meet the concept's objectives. A Mandatory Delivery Date field can contain the date by which the project must be implemented to comply with any legal, regulatory, or external mandates. A Mandate Requestor field can specify who is classifying the concept as a mandate and describe why it is considered a mandate. A Concept Representative field can contain the name of the concept representative, and the representative's phone number, department name, and business unit. A Concept Subject Matter Expert field can contain the name, phone number, department name, and business unit of an individual possessing detailed knowledge of the concept. A Project Manager field can contain a project manager's name, phone number, department name, and business unit. A Sponsoring Director field can contain the name of a sponsoring or funding director and the director's phone number, department name, and business unit. A Sponsoring VP field can contain the name of a sponsoring or funding vice president and the vice president's phone number, department name, and business unit. A Funding Links field can indicate if the concept is part of another project, or if it is funded by an existing project authorization, or if it is associated with any previously funded project activity. Several sub-fields can be present within the Funding Links field. A Project Authorization field can contain the project authorization number associated with the related project. A Business Case/Project Name field can contain a short description of any business cases or projects that are financially linked to the concept. A Hardware Project Authorization Number field can contain the project authorization number associated with any related hardware costs. Various other sub-fields can be present to list identification numbers associated with the related project.

The general administrative information subcategory of Section 1 of the CARD can also contain several questions to be answered by the concept's sponsor. One question can deal with whether the concept was reviewed by the sponsoring organization during a budgeting process. Another question can concern whether or not the concept is in a system plan, capital budget, business unit budget, affordability plan, or other budget. Another question can ask whether or not the concept has been through an Enterprise Development Process Business Unit Ideation review. Another question can concern whether or not the concept has been reviewed in a Feasibility Determination session. Another question can deal with whether or not the concept has been reviewed in a previous Concept Estimation session.

In the concept category subcategory within the general administrative information category in Section 1 of the CARD, a category can be chosen that describes the concept. Categories can include New Product or Service, Product or Service Enhancement, Infrastructure Buildout or Enhancement, and Operational Process Improvement.

The concept purpose and objectives subcategory within the general administrative information category can describe what the concept is trying to accomplish for a business unit. Typically in narrative form, information in this subcategory defines the scope and purpose of the concept and defines the business unit objectives the concept will satisfy.

The scope of costing information subcategory within the general administrative information category can describe any special considerations or variations from the standard scope of costing information for the concept. The cost estimation process attempts to capture the total project costs associated with planning, designing, and implementing a concept. The total cost can be derived by identifying all impacted areas and capturing the labor, hardware, software, and third-party costs required to implement the concept. The cost estimation process typically does not include incremental workforce expansion, recurring maintenance costs, or growth costs associated with a concept. Any known cost or budget limitations with the concept can be described.

Within the context information category in Section 1 of the CARD, subcategories can include strategic alignment and drivers, assumptions and risks, dependencies and synergies, product/service relationships, and the expected external customer experience. The strategic alignment and drivers subcategory within the context information category can describe how the concept aligns with the business unit's strategies and/or major initiatives. Factors driving the need for the concept can be described as well as the manner in which the concept supports those drivers. The assumptions and risks subcategory within the context information category can describe in detail any known assumptions or risks associated with the implementation of the concept. The business impact of not implementing the concept can also be described. The dependencies and synergies subcategory within the context information category can list any existing concepts or projects the concept may depend on or that may depend on the concept. Any known synergies with other concepts or projects can be listed and the nature of the dependencies or synergies can be described. The product/service relationships subcategory within the context information category can identify products and services that the concept may impact and/or relate to and can describe the relationship. The expected external customer experience subcategory within the context information category can describe how the customer might view, perceive, and touch the product or service impacted by the concept. The description is typically written from the external customer's perspective.

Within the target information category in Section 1 of the CARD, subcategories can include target market/customer segments, target sales channels, target marketing service areas, and projected volume of business/traffic. The target market/customer segments subcategory within the target information category can identify, at a high level, the categories used to target customers. Examples of market segments can include high-end business, low-end business, government, hospitality, and wholesale. The target sales channels subcategory within the target information category can identify the channels used for marketing and/or sales activities. Examples of target sales channels can include direct sales, indirect sales, and e-commerce. The target marketing service areas subcategory within the target information category can identify the service areas that the concept is targeted for. For each service area, any known regions, locations, and/or pertinent geographic information that may impact the concept approach can be specified. Examples of service areas can include domestic, North America, and international/offshore. The projected volume of business/traffic subcategory within the target information category can identify the forecasted volume of business and/or traffic as well as the expected time frame for customer ramp-up. Examples that are typically considered for a telecommunications company can include customer volume, call volume, average time per call, the number of concurrent users, volume peaks, and time peaks.

The capabilities and constraints category in Section 1 of the CARD can describe the capabilities and constraints that the concept is introducing, expressed in terms of business requirement statements. For product or service-related concepts, these statements typically describe what is required, not how it will be developed. Expected service performance requirements, where applicable, can also be stated. A set of questions can be included in this category to help elicit, capture, and categorize the requirements. For a telecommunications company, these questions can be based on and aligned with the business domains described in the enhanced Telecom Operations Map (eTOM) published by the Tele-Management Forum. Business domains can also be framed in the context of the product development and customer life cycle. This framework can comprise of the following business domains: customer acquisition, service delivery, customer care, service assurance, revenue management, infrastructure buildout, and customer interface management. One skilled in the art will appreciate that other names can be used for these domains as long as the names refer to domains that are similar to the domains referred to by these names. Each of these business domains can be supported by various applications systems, providing automation or systematic functionality within that business domain. For example, the Customer Information System (CIS) supports the customer acquisition domain. The Invoice Processing System (IPS) and the Message Processing System (MPS) support the revenue management domain.

For each of these business domains, a set of questions can be present in the capabilities and constraints category of Section 1 of the CARD. By answering these questions, a concept sponsor can further define the business requirements of a concept. Examples of the kinds of questions which may be asked in one embodiment follow. The customer acquisition questions can deal with obtaining business, including selling and order handling. The service delivery questions can concern the processes that enable requests for service to be fulfilled. The customer care questions can concern the processes that control how contacts from customers are managed. The service assurance questions can concern processes for guaranteeing and maintaining services and infrastructure. The revenue management questions can concern processes related to managing the financial aspects of customer services. The infrastructure buildout questions can concern processes that provide the network foundation needed to conduct business. The customer interface management questions can concern processes that enable customers to interact directly with a provider of a product or service. Another set of questions can concern supporting processes such as decision support, security issues, legal issues, financial decision support and reporting, real estate, supply chain management, and vendor equipment and services.

Section 2 of the CARD can describe the approaches to a concept, the impacts of those approaches, and a recommendation of whether to proceed to the Estimation step. A subsection of Section 2 can describe architectural approaches to the concept, encompassing both network and IT perspectives and including integration with third-party vendor solutions. This subsection also addresses any proof of concept and/or certification activities required for implementing the concept. If multiple approaches are listed, each approach is typically listed in the same CARD but is evaluated and estimated separately. This subsection can indicate whether an Architecture Blueprint is needed to finalize architecture determination and/or architecture details and, if so, the organization taking the lead to produce it.

Another subsection of Section 2 can describe the critical functional impacts of each approach to the concept. Functional areas that can be considered include network design such as computing platforms, connectivity, transport, and management systems; network operations such as provisioning, translations, tools, test equipment, methods, and procedures; access operations, planning, and verification such as access service requests, capacity, regulatory requirements, and reporting; network capacity required beyond the current plan; security such as hardware, connectivity, procedures, policies, and software; conversion such as customer conversion, data conversion, software conversion, and connectivity/network conversion; billing and finance operations such as invoice changes, reporting, rating, taxing, usage processing, settlements, and receivables management; enhanced platforms and services such as relay services, operator services, and customer services; third-party and vendor management; and legal and regulatory issues such as new requirements and risks.

Another subsection of Section 2 can indicate the required or desired testing approach, from both product and user perspectives. The benefits and risks associated with the testing approach can be described. Another subsection of Section 2 can provide a recommendation for one of the approaches, a summary of the approach, and a feasibility determination. The preferred approach or approaches can be listed and a recommendation of whether to proceed with the concept can be given. If proceeding is not recommended, the reasons for not proceeding and an alternative course of action can be given. Known assumptions, issues, and risks potentially impeding the successful implementation of the concept, including issues pertaining to expected delivery timeframe, high-level cost, and other critical factors can be summarized.

Section 3 of the CARD can describe the systems that might be impacted by the concept's various approaches. For each approach, the impacted system and its identification number can be listed as well as the nature and level of the impact.

Section 4 of the CARD can describe the results of the estimation of the concept. This section can provide an overall summary of concept details and the detailed level of effort (LOE) required to deliver the concept described within the CARD. If multiple approaches are listed in the CARD, a separate LOE is provided for each. A subsection of Section 4 can be an accounting by software development areas of the level of work effort required to implement the concept. Another subsection can be an accounting by business operations areas of the level of work effort required within the identified business areas to implement the concept. Another subsection can capture the additional concept costs, such as new hardware, third-party software, or external labor that might occur. Another subsection can describe the concept sizing delivery interval. An expected cycle time or delivery interval in this subsection can provide an estimate of the variance in weeks available to implement the project compared to the Expected Delivery Date requested by the sponsor. In some embodiments, the number of weeks available to obtain funding can also be provided. This can be important since the average project cycle time typically does not start until funding is approved. The intent is to provide a first awareness of the expected delivery interval and hence help manage the sponsor's expectation.

In traditional procedures for developing software projects within an enterprise, a proposed project would typically be introduced by a unit of the enterprise sponsoring the project. The sponsoring unit would describe an opportunity or a problem and provide presumed solutions to the problem. The presumed solution inherently includes presumed system impacts, operational impacts, and an overall approach to the problem. The description of the opportunity or problem and the presumed solution would be sent directly to the software development groups that were presumed to have expertise in the problem domain. Each software development group, after consulting directly with potential users and with other units that might be affected by the proposed project, would provide the sponsoring unit with its estimate of the effort that would be required from the group to complete the project. The development groups typically created these estimates independently without a clear and common vision for the business needs, for potential approaches, or for the target architecture. The estimates for each individual group would be combined to create the total estimated development cost for the project. Since there was little communication between groups, gaps and/or overlaps could occur among the individual estimates from the different groups. Also, the groups might not have a clear and common vision of the overall goal of the project and how it impacts the IT or network architectures or the operations, causing potential misalignments and duplication of effort between the various development organizations and most importantly contributes to a spaghetti-like IT architecture.

In an embodiment of the invention, the business opportunity or problem is communicated with domain architects rather than applications programmers. A conceptual architect can be defined as someone who has overall knowledge of and responsibility for all the systems and connecting architecture within a given business domain, knows how different systems work together, and has the ability to apply new technology in an existing environment. An applications programmer, on the other hand, tends to be an expert in a relatively narrower field and typically has only limited knowledge of the overall architecture of the entire domain or the enterprise. Also, a conceptual architect tends to perform a greater role in functional planning than a programmer. There is typically a single conceptual architect for each business domain in an enterprise. In an embodiment of the invention, the business domains can be those specified by the eTOM, as indicated above.

In a typical sequence of events, once a sponsoring unit (e.g., business unit, a network or IT unit, or some other unit within an enterprise) selects a concept that is aligned with the business intent, a concept author from or on behalf of the sponsoring unit describes the concept in a concept document. In an embodiment of the invention, the concept can be described in Section 1 of the concept document. The concept document is then submitted to at least one conceptual architect who can review the concept document and determine which business domains might be affected by the proposed project. The conceptual architects for each business domain that may be affected by the proposed project can then determine potential approaches and review them at a feasibility determination meeting with the sponsor of the project. Other potentially affected groups, such as operations, may also be present. In a preferred embodiment, at least one conceptual architect and preferably a group of conceptual architects from affected domains may meet prior to the feasibility determination meeting (in a planning meeting) to begin determination of approaches, and initially assess operations, IT, and network impacts. In this preferred embodiment, the feasibility determination meeting with the project sponsor is instead focused on reviewing and validating the approaches and impact assessments. In other embodiments, the feasibility determination meeting covers both the initial determination and the validation of approaches and impact assessment. This is contrasted with traditional procedures where multiple individual meetings might be held with the sponsor and programmers from the various affected applications. For purposes of this specification, the term “meeting” may include a face-to-face gathering, and any collective, collaborative communication, such as a conference call, phone call, or web-enabled communication among the members of the group. During the feasibility determination, the conceptual architects typically define the scope and the architectural impact of the project, identify potentially impacted systems within each business domain, and define potential approaches. The conceptual architects also typically attempt to determine the architectural requirements of the project, describing critical components necessary for the application, technical, and data architects to understand the scope of a project's technical requirements. Such information could include the personnel who will need access to the new data, the new connections among systems that might be needed, the changes in ports that might occur and a general idea of the information flow that might occur between systems. The conceptual architects and operations representatives collaborate in determining the feasibility of the proposed approaches, and in deciding whether the concept review process should proceed to the Estimation step. In some embodiments they may also specify and recommend an approach, they may assign roles for the project, and they may begin work on identifying and beginning testing approaches.

The proposed approaches and feasibility assessment can be placed in Section 2 of the concept document. Determination of the impact to downstream systems and the roles these systems will play is typically done outside the feasibility determination meeting. The description of the impacted systems can be placed in Section 3 of the concept document. The concept document is then made available to the applications system analysts. If a decision was made to produce an Architecture Blueprint during the feasibility determination meeting, one would be created outside the meeting.

Using this information, representatives of the impacted systems (often application system analysts) can estimate the level of effort (LOE) required for their portions of the project. The application system analysts might contact the conceptual architects, the end users, or other programmers if clarification is needed. However, the application system analysts typically do not contact the business sponsors of the project. The LOEs determined by the various applications programmers can be placed in Section 4 of the concept document. At this point, the document can be considered complete and can be sent back to the sponsor to be revised, approved or rejected.

With this approach, an overall view of all impacted systems, including indirectly impacted systems, and a definition of the roles and responsibilities of those systems can be provided. Decisions are made with a view to the long-range plans and overall direction of the enterprise rather than to a specific problem solution.

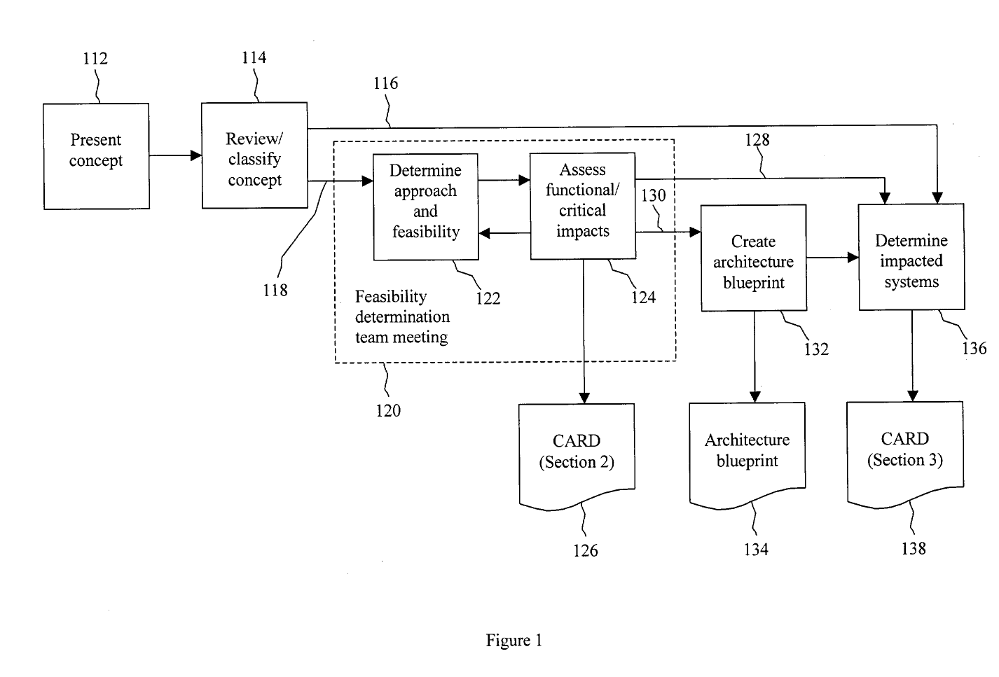

An embodiment of the Feasibility determination process is illustrated in FIG. 1. In box 112 a concept is presented by a sponsoring organization. In box 114 the concept is reviewed for completeness and a feasibility process path is determined. Two paths, 116 and 118, can be followed from box 114. If it is determined in box 114 that a feasibility determination meeting is not required, path 116 is followed to box 136 where the impacted systems and the nature and level of the impact are determined. If it is determined in box 114 that a feasibility determination meeting is required, path 118 is followed and a feasibility determination team meeting is held as shown in box 120. The feasibility determination team meeting 120 comprises boxes 122 and 124. In box 122 an approach to the concept and the feasibility of the concept are determined based on network capabilities, systems capabilities, third party vendors, expected volume of business and traffic, and expected delivery date. In box 124 functional and critical impacts are assessed based on operational impacts (such as business, network, finance, and billing impacts), security, legal and regulatory issues, customer conversion, and test approaches. After functional and critical impacts are assessed in box 124, Section 2 of the concept document can be completed as shown in box 126. Two paths, 128 and 130, can be followed from box 124. If an Architecture Blueprint is not required, path 128 can be followed to box 136 where the impacted systems are determined. If an Architecture Blueprint is required, path 130 is followed to box 132 where the Architecture Blueprint is created. The Architecture Blueprint is shown in box 134 as the output of this process. After the Architecture Blueprint is created in box 132, the impacted systems are determined in box 136. Section 3 of the concept document can then be completed as shown in box 138.

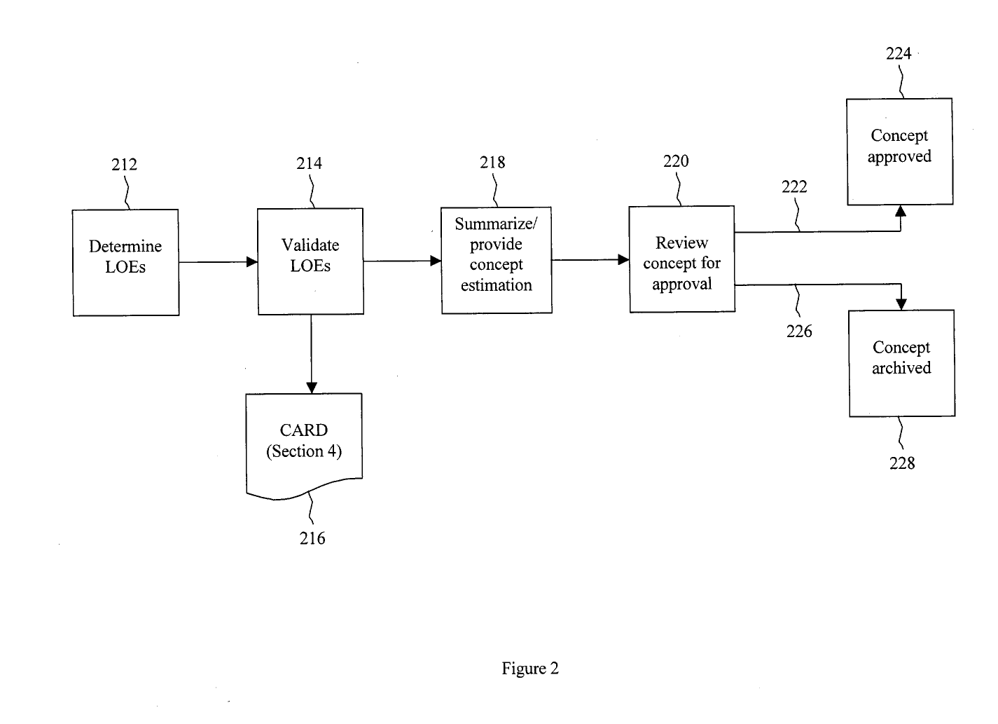

An embodiment of the Estimation process is shown in FIG. 2. In box 212 a Level of Effort (LOE) is determined based on Sections 1 through 3 of the concept document and on the Architecture Blueprint if one was produced in the Feasibility step. The LOE covers application systems hours and other known costs such as network and bus operations. In box 214 the LOE is validated by conceptual architects to ensure that the LOE estimates are reasonable and appropriate. Section 4 of the concept document can then be completed as shown in box 216. After the LOE has been validated in box 214, the concept is summarized in box 218 and an estimate for the concept is provided to the concept sponsor for review and approval. In some embodiments, the estimate includes updated Sections 1 through 4 of the CARD and an updated Architecture Blueprint if one was produced. Feedback on the feasibility of the expected delivery date and an expected delivery interval can be provided at this point. Next, the concept is reviewed for approval in box 220. From this point, path 222 is taken to box 224 if the concept is approved for analysis. Alternatively, if the concept is dropped or postponed, path 226 is taken to box 228 where the concept is archived.

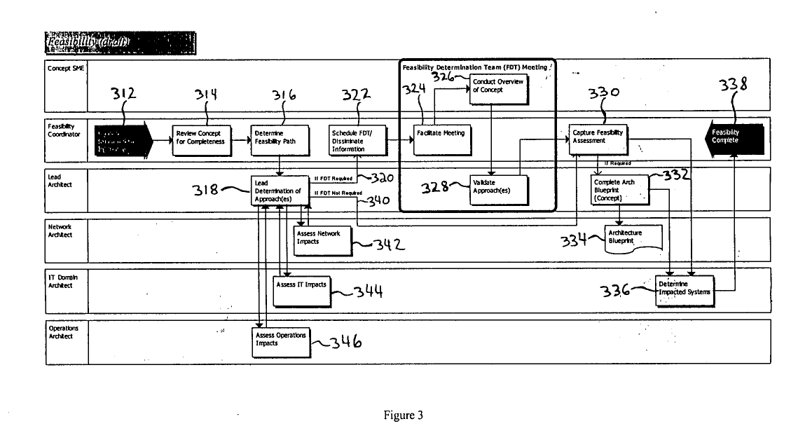

An alternative embodiment of the Feasibility determination process is illustrated in FIG. 3. In box 312 a feasibility coordinator submits a concept to the Feasibility determination process. The feasibility coordinator reviews the concept for completeness in box 314 and determines the feasibility path in box 316. In box 318 a lead architect leads the determination of the approach or approaches that will be taken toward the concept. If the lead architect determines that a feasibility determination team (FDT) meeting is required then path 320 is followed from box 318 to box 322. In box 322 the feasibility coordinator schedules the FDT meeting and disseminates information relevant to the meeting. In box 324 the feasibility coordinator facilitates the FDT meeting, which is typically attended by at least one concept subject matter expert and at least one lead architect. A concept subject matter expert can conduct an overview of the concept in box 326. A lead architect can validate an approach or approaches to the concept in box 328. The feasibility coordinator can capture the feasibility assessment in box 330. If it is determined that an architecture blueprint is needed, a lead architect and a network architect can complete the architecture blueprint in boxes 332 and 334, respectively. In box 336 an IT domain architect can then determine the systems that may be impacted by the concept. The Feasibility determination process can then be considered complete in box 338.

If, in box 318, it is determined that an FDT meeting is not required, then path 340 is followed from box 318 to box 330. The steps in boxes 330, 332, 334, 336, and 338 as described above are then followed.

In box 318, the lead architect can consult with other architects in determining the approach or approaches that will be taken toward the concept. In box 342 a network architect can assess network impacts, in box 344 an IT domain architect can assess IT impacts, and in box 346 an operations architect can assess operations impacts.

Although only a few embodiments of the present invention have been described, it should be understood that the present invention may be embodied in many other specific forms without departing from the spirit or the scope of the present invention. The present examples are to be considered as illustrative and not restrictive, and the invention is not to be limited to the details given herein, but may be modified within the scope of the appended claims along with their full scope of equivalents.

1. A process for defining and selecting integrated potential software, hardware, and networking approaches for addressing a business need comprising:
providing an identification of a business need to at least one conceptual architect in a concept document, the concept document provided to the at least one conceptual architect including
context information regarding where the business need fits into an enterprise and with related projects,
target information regarding what the intended market uses and volumes are for the business need, and
detailed information on capabilities and constraints that the business need is introducing;
the at least one conceptual architect identifying the potentially impacted business domains using the context information, target information, and the capabilities and constraints information provided in the concept document;
holding a meeting which includes a representative of IT, a representative of network, and a representative of operations from each potentially impacted business domain wherein the meeting results in additions to the concept document identifying at least one proposed approach, the additions to the concept document including
architectural approaches to each proposed approach encompassing network and information technology (IT) perspectives;
critical functional impacts of each proposed approach; and
required or desired testing for each proposed approach;
identifying impacted systems for each proposed approach by examining the additions to the concept document including the architectural approaches, the critical function impacts, and the testing for each proposed approach;
providing the entire concept document to representatives of each impacted system for feedback before final selection of a proposed approach or initiation of efforts to implement a proposed approach; and
selecting a final selection from the at least one proposed approach with a view of the long-range plans and overall direction of an enterprise rather than to a specific problem.

2. The process of claim 1 further comprising the at least one conceptual architect being a plurality of conceptual architects, wherein the plurality of conceptual architects identify the potentially impacted business domains in the concept document and further initially identify at least one proposed approach to take to the meeting of the representatives of the potentially impacted business domains.

3. The process of claim 1 further comprising the representatives of each impacted system providing estimates of the Level of Effort for a proposed approach.

4. The process of claim 1 further comprising creating an architecture blueprint as a result of the meeting.

5. The process of claim 1 wherein the business domains comprise infrastructure buildout, customer acquisition, service delivery, revenue management, customer care, and service assurance.

6. The process of claim 1 wherein the impacted systems within the infrastructure buildout business domain can comprise a network provisioning system, the impacted systems within the customer acquisition business domain can comprise sales and order creation systems, the impacted systems within the service delivery business domain can comprise network facility management systems, the impacted systems within the revenue management business domain can comprise invoice processing systems and message processing systems, the impacted systems within the customer care business domain can comprise customer care operations, and the impacted systems within the service assurance business domain can comprise performance monitoring and troubleshooting systems.

7. The process of claim 1 wherein the concept document provided to the architect is a Concept Analysis Review Document comprising a section with concept information and the sponsor view of the concept, another section with an approach and feasibility determination, another section describing systems that might be impacted, and another section with concept estimation results.

8. The process of claim 7 wherein the section with concept information and the sponsor view of the concept comprises a subsection describing the capabilities and constraints that a proposed approach to a problem is introducing.

9. The process of claim 8 wherein the capabilities and constraints are categorized according to the business domains within an enterprise.

10. The process of claim 8 wherein the section with concept information and the sponsor view of the concept further comprises a subsection of general administrative information, another subsection of context information, and another subsection of target information.

11. A method of determining a potential approach and estimating a level of effort for an identified concept comprising:
having a business unit sponsor identify a concept including a business intent and an object desired;
identifying all business domains potentially impacted by analyzing a context information, a target information, and a capabilities and constraints information associated with the concept;
holding a meeting which includes a representative of IT, network, and operations from each potentially impacted business domain wherein a plan is created that establishes an at least one potential approach to the concept, the feasibility of the approaches, the systems that are actually impacted, and the functions and organizations that are impacted by the concept;
recording all established potential approaches in a concept document;
providing the entire concept document to representatives of each actually impacted system that will complete the project; and
having the representatives of each actually impacted system that will complete the project estimate a level of effort needed to complete their portion of the project based on the information in the entire concept document.

12. The method of claim 11, further comprising after identification of a concept by a business unit sponsor and before holding a meeting with representatives of each potentially impacted business domain, holding a meeting with a plurality of conceptual architects, wherein the plurality of conceptual architects identify the potential approaches to take to the meeting of the representatives of the potentially impacted business domains.

13. The method of claim 11 wherein the concept document is a Concept Analysis Review Document comprising a section with concept information and the sponsor view of the concept, another section with an approach and feasibility determination, another section describing systems that might be impacted, and another section with concept estimation results.

14. The method of claim 13 wherein the estimate of the level of effort is placed in the concept estimation results section of the Concept Analysis Review Document.

15. The method of claim 11 further comprising creating an architecture blueprint as a result of the meeting.

16. The method of claim 11 wherein the business domains comprise infrastructure buildout, customer acquisition, service delivery, revenue management, customer care, and service assurance.

17. The method of claim 11 wherein the impacted systems within the infrastructure buildout business domain can comprise a network provisioning system, the impacted systems within the customer acquisition business domain can comprise sales and order creation systems, the impacted systems within the service delivery business domain can comprise network facility management systems, the impacted systems within the revenue management business domain can comprise invoice processing systems and message processing systems, the impacted systems within the customer care business domain can comprise customer care operations, and the impacted systems within the service assurance business domain can comprise performance monitoring and troubleshooting systems.

18. A method of determining a potential approach including a testing approach and estimating a level of effort for an identified concept comprising:
having a business unit sponsor identify a concept including a business intent and an object desired;
identifying all business domains potentially impacted by analyzing a context information, a target information, and a capabilities and constraints information associated with the concept;
holding a meeting which includes a representative of IT, network, and operations from each potentially impacted business domain wherein a plan is created that establishes an at least one potential approach to the concept, the feasibility of the approaches, the systems that are actually impacted, and the functions and organizations that are impacted by the concept;
recording all established potential approaches in a concept document;
indicating in the concept document an at least one testing approach for one or more of the established potential approaches;
including in the concept document a benefits and risks associated with the at least one testing approach;
providing the entire concept document to representatives of each actually impacted system that will complete the project; and
having the representatives of each actually impacted system that will complete the project estimate a level of effort needed to complete their portion of the project based on the information in the entire concept document including the at least one testing approach.
